(19) United States
(12) Patent Application Publication
(10) Pub. No.: US 2014/0049797 A1
(43) Pub. Date: Feb. 20, 2014

(54) PRINTING SYSTEM, A METHOD OF PRINTING A PRINT JOB, AND A PROGRAM

(71) Applicant: Karsten Huster, Lienen (DE)

(72) Inventor: Karsten Huster, Lienen (DE)

(73) Assignees: CANON EUROPA N.V., Amstelveen (NL); C/O CANON EUROPA N.V., Amstelveen (NL)

(21) Appl. No.: 13/980,540

(22) PCT Filed: Jan. 17, 2012
(86) PCT No.: PCT/EP2012/050656

§ 371 Date: Nov. 6, 2013

(30) Foreign Application Priority Data
Jan. 19, 2011 (GB) 1100922.2

(51) Int. Cl. G06F 3/12

(52) U.S. Cl. CPC G06F 3/1296
USPC 358/1.15

(57) ABSTRACT

A printing system with at least one printer and at least two print servers is provided for printing a print job on a selected printer. The print job is stored on one of the print servers and print job information about the stored print job on the storing print server is shared between the print servers. In case of a request for print out the print job on the selected printer, the print job is sent from the storing print server to the selected printer based on the print job information.

### BACKGROUND OF THE INVENTION

### Field of the Invention

The present invention is generally related to a printing system, a method of printing a print job, and a printing program.

One disadvantage of big networks of print servers is that the costs of transmission of data increase with the data volumes of the print documents and the speed of transmission decreases.

Currently there is, however, no convenient and resource-efficient way for sharing print documents within a network of print servers. In a commonly used print server network, the print documents may be stored on some of the print servers of the network and may be synchronized after certain times between the relevant print servers. Because of that, in some print server environments, which have to ensure highly available print jobs within the system, one print job is stored multiple times on different print servers. Alternatively, according to changing printing conditions within the network the print jobs are routed to different print servers. One disadvantage of these print server configurations is that the transmission of the print jobs over the network causes high transactions costs.

Also the management of one print job stored multiple times on different print servers is very complex and could be therefore erroneous.

According to WO 2008/129011 A1 a print server is provided for connection to a network including at least one other server and at least one printer. The print server stores a list of users including for each user a server associated with that user. If a request is received from a user, the server refers to the list to determine which server the user is associated with. The print server is configured to request print jobs from and to send jobs to the print server with which the user is associated in order to minimise long distance traffic over the network.

However, a disadvantage of these known arrangements is that the print jobs are stored or routed several times on different print servers and causes therefore costs of transmission of data and decreases the speed of transmission of the network. Especially if the print servers are located within different countries the costs of printing are undesirably high and the speed of transmission and therefore the rate of printing undesirably low.

### SUMMARY OF THE INVENTION

It is an object of the present invention to alleviate some of the problems identified above. Another object of the present invention is to use the resources of the print servers and printer within the network for printing print jobs in an efficient and easy way.

According to a first aspect of the present invention there is provided a print system according to claim 1. The print job is stored on one of the print servers and information about the stored print job is shared between the print servers of the network. Print job information may be any information about the print job, such as the print job name, file size, the related user and/or storing location on one of the print servers. Print job information may be extracted directly from the print job, such as the extraction from the header of the print job, or may be monitored within the printing system during generating and/or sending of the print job within the printing system.

In case of a request for printing out the print job on the printer, the print job is sent from the storing print server via the network to the printer. Therefore the print job is stored only once on the storing print server, but all relevant information about the print job is shared between all print servers—and perhaps even other devices—of the network. Instead of transmitting a print job of big file size several times over the network, only the relevant print job information about the print job are shared between the print servers. The print job is still stored on the storing print server. These print job information have a much smaller file size compared to the related print job and reduce therefore the transmission costs and increase the transmission capabilities of the network.

Preferably, the print job format is a postscript or printer command language format and in case the postscript or printer command language format of the format convertible print job is not usable for the selected printer a raster image processor converts the format of the format convertible print job into an applicable format for the selected printer. After that the print job is released to the selected printer. The analysis for the possible applicable print format for the selected printer and/or conversion of the convertible print job into one applicable print format of the print job may be managed by any of the print servers. It would be appreciated if the storing print server or one print server designated for the selected printer manages the analysis and/or conversion of the print format in case of necessity in an applicable print format of the print job for the selected printer.

In other embodiments, the print job information about the stored print job is shared between the print servers and the printers via the network. In this case the print job could be indentified very quickly within the network and also easily routed to the selected printer. Especially if the storing print server is responsible for the analysis of the print format and/or—in case of necessity—for the print format conversion of the format convertible print job. In this case the other print servers of the network may not have to care about the analysis of the print format and/or the conversion of the print format of the format convertible print job. Therefore no further transmissions between the print servers are needed.

Further, the printer is identified within the network by a unique address and a device agent installed on one of the print servers prepares and releases the print job to the selected printer by using the unique address. Preferably, the unique address is an internet protocol address, such as used for the World Wide Web. Favourably, the device agent gets all print job information and also information about the selected printer and sets up the right printer driver in case of a necessary print format conversion.

The printing system may be configured so that the print job is generated by the storing print server and is released to the selected printer by an electronic data exchange via the network based on a network protocol, such as Extensible Markup Language (XML) or Hypertext Transfer Protocol (HTTP). Also the print job is used to send directly to an IP address or Domain Name System (DNS) name related with the selected printer within the network without involving a print spooler. Therefore the print servers do not have to provide a print queue infrastructure and also no print spooler processing or interfaces for the print job, such as Graphics Device Interface (GDI) conversions, are needed. These embodiments of the present invention also reduce the necessary resources for file transmissions between the print servers and improve therefore the available network resources of the print servers for other purposes.

The IP address or DNS name can be retrieved from multiple sources within the network. The printing system first attempts to lookup for a printer by the specified name. If a specified name is found and the status of the printer is not offline or erroneous, the printing system will utilize the printer. If the specified name does not correspond to one printer name, the printing system will do a DNS lookup for checking known IP addresses or DNS names within the network.

In some embodiments, each printer is designated for one print server respectively and this designated print server manages the designated printer. In case a number of printers are designated each to a designated print server, the routing and print job management of every print job within the network may be managed by the designated print server exclusively. Also the analysis and/or conversion of the format convertible print job and/or an automatic allocation of print costs to users, user groups, or cost centers may be orchestrated by the designated print server. The user may communicate with the devices within the network, such as print server or printer, via a web browser using the IP addresses or DNS names within the network.

Also scanned images may be archived on the designated print server in case the scanned images are scanned on one selected multifunctional printer with scanning capabilities connected directly with the designated print server.

It will be appreciated that the print job is releasable from the storing print server by the printer and/or by another print server and/or by a device connectable to the network, such as a mobile phone, a tablet-PC or a laptop. The printers and/or print servers and/or devices may be connected by a wired or wireless connection link to the network, where necessary by using appropriated gateways.

The actual and/or future status of a number of printers within the network is monitored and used for selecting and displaying appropriate printers for a possible printing out. In such embodiments only available printers are displayed and therefore the possible selection of actually erroneous or jammed printers is avoided. Additionally the appropriate printers may be displayed according to pre-defined parameters or actual conditions, such as the nearest printers in the vicinity of the actual position of the user using the mobile device.

Preferably, the storing print server is the print server which is normally used by the user for his or her print management. In such embodiments also the transmissions between the print server and the selected printer, which in this case is designated and linked directly to the designated print server, is reduced. Therefore not only the transmissions between the print servers within the network are reduced, also the network traffic between the print servers and selected printers is minimized. The resources of the print servers and the network are skimped, which has positive impact on the availability of the entire network by increasing the transmission rate and by decreasing the transmission costs per print job.

Preferably, the storing print server is the print server, which is designated for the normally selected printer of the user.

It would be appreciated that the print server and/or the printer and/or release device synchronize the print job information and/or information about the storing print server within pre-defined time intervals, such as every five minute, and/or if a change of print job information is detected. Further, in case information changes are detected on at least one of the directly connected print servers, the print servers synchronize each other. Therefore the start of the synchronisation is limited at a specific area of the network within directly connected print servers. Therefore the entire network is not affected in the beginning of the synchronisation of print job information between the directly connected print servers. Because of that, IT administrators have the opportunity to manage the synchronisation process of the print job information within the entire network or for specific network sections.

Preferably, the storing print server transmits accounting information after the release of each print job to a cost centre. In such embodiments the storing print server is responsible for the cost accounting of print jobs, stored on this storing print server. Double-accounting for one print job is avoided by this clear definition of responsibilities. Further, the accounting information may be also shared between the print servers of the network, similar to the print job information.

The print job information and/or the storing print server may comprise the name, storage location, data size, the related user and/or security information of the print job.

According to a further aspect of the present invention a number of print server networks are connected via gateways, especially internet gateways, and/or web/mail servers with each other. The print job information is shared between the connected networks.

According to a second aspect of the present invention there is provided a method of printing a print job within a printing system. The print job is stored on one of the print servers and the print servers share the print job information between each other within the network. In case of the request for print out the print job on the selected printer the print job is sent from the storing print server via the network to the selected printer.

According to a third aspect of the present invention there is provided a program which when run on a computer means of the printing system causes the computer means to perform a method for printing. According to a further aspect of the present invention there is provided a storage medium storing a program which when run on a computer means of the printing system causes the computer means to perform a method for printing within the printing system.

### BRIEF DESCRIPTION OF THE DRAWINGS

An embodiment of the present invention will now be described, by way of example only, with reference to the accompanying drawings in which:

FIG. 1 is a schematic diagram showing three networked print servers with selected multifunctional printers (MFP).

FIG. 2 shows the main features of the hardware of the multifunctional printer (MFP).

FIG. 3 is a chart showing the routing of a print job from a storing print server, which is also the designated print server, to the selected printer.

FIG. 4 is a chart showing the routing of one print job from the storing print server to the designated print server of the selected printer.

FIG. 5 shows the routing of one print job from the storing print server to the designated print server, which converts the print job in an appropriated print format for the selected printer.

FIG. 6 is a chart showing the routing of one print job within the network and the release of the print job is managed by a mobile device.

FIG. 7 shows the routing of one print job within the network.

FIG. 8 is a Unified Modelling Language (UML) diagram showing three print servers and one printer.

### DESCRIPTION OF THE EMBODIMENTS

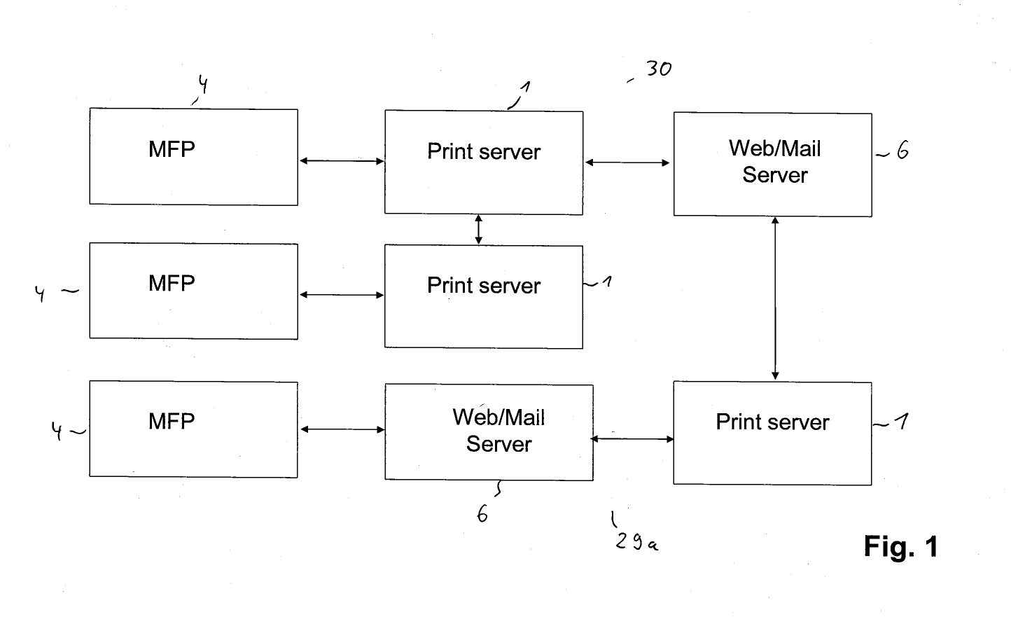

FIG. 1 shows a printing system 30 with three print servers 1 connected via a network 29a, such as the World Wide Web (WWW) or a Wireless Area Network (WAN). The print servers 1 are configured to communicate with each other, for example based on the HTTP protocol. Use of HTTP protocol avoids difficulty with communication through firewalls between different networks. The print servers 1 may be connected directly with each other or by a web/mail server 6. Each printer 4 may be assigned to one specific print server 1. The printer 4 is identified within the network 29a by a unique address. A device agent installed on one of the print servers 1 and/or printers 4 prepares and releases the print job 23 (not shown in FIG. 1) to the printer 4 by using the unique address. In the embodiment of FIG. 1 each designated print server is managing one designated printer 4 and the related print job 23,27 (not shown in FIG. 1) for the designated printers 4. This can enhance the printing system functionalities, especially if the designated printer 4 is an inkjet printer with limited network resources and reduced print job management capacities.

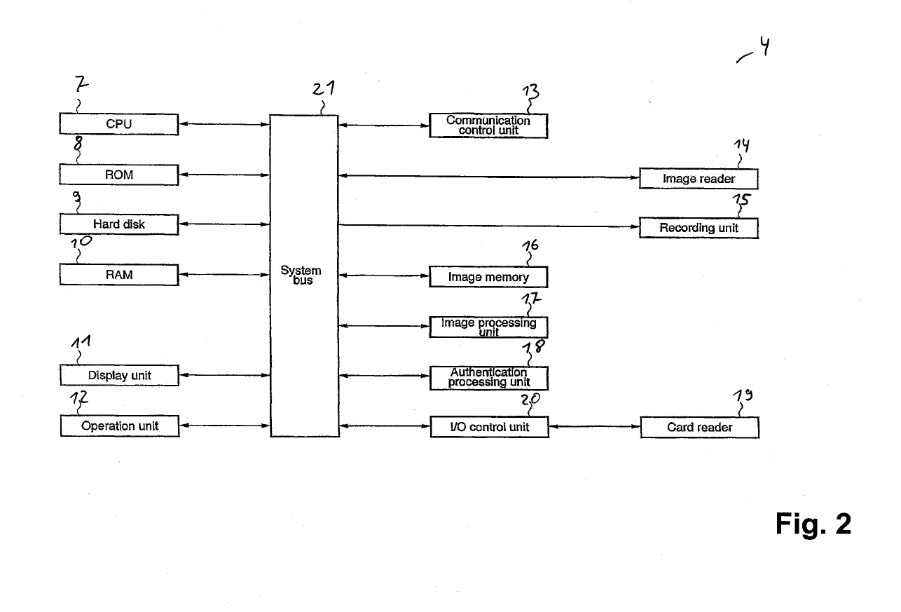

FIG. 2 shows the hardware configuration of the printer 4, especially a multifunctional device, with printing, scanning and communication capabilities. The printer 4 comprises a CPU 7, a ROM 8, a hard disk drive 9, and a RAM 10. These components are standard hardware components for computers and other devices and perform their usual functions. The printer 4 further comprises a display unit 11, an operation unit 12, a communication control unit 13, an image reader 14, a recording unit 15, an image memory 16, an image processing unit 17, an authentication unit 18, a card reader 19 and an I/O control unit 20. The display unit 11 is a touch-screen LCD display provided on the printer 4 to allow a user to make selections and view information on the printer 4, such as requesting the printing of print job stored on a print server 1. The operation unit 12 is a keypad and other buttons to allow a user to enter settings and other information to the printer 4. The communication control unit 13 is provided to allow the printer 4 to communicate over a LAN with the print server 1 (not shown in FIG. 2). The printer 4 may be also a scanner that allows scanning of documents. The recording unit 15, shown in FIG. 2, represents parts of the printer 4, dedicated to printing. The recording unit 15 functions to print image data onto a recording medium and output the recording medium for collection by a user. The image memory 16 is a memory provided for storage of image data during scanning by the image reader 14 or printing by the recording unit 15. The image-processing unit 17 represents various application specific integrated circuits (ASIC) provided in the printer 4 in order to increase the speed of certain image processing operations, such as conversion of scanned R,G,B data into C,M,Y,K data during a copying operation. The authentication processing unit 18 is provided in order to authenticate user details received from the card reader 19. Data from the card reader 19 is received at the authentication unit 18 via the I/O control unit 20. The authentication unit 18 may be implemented by software run using the CPU 17 and RAM 10 rather than as a separate hardware component. The components 7 to 20 described above are interconnected via a system bus 21.

The printer 4 runs an operating system. In this particular embodiment the operating system is the Multifunctional Embedded Application Platform (MEAP) operating system provided on multifunctional device devices sold by Canon®. The operating system allows the running of JAVA programming applications and also includes a web interface.

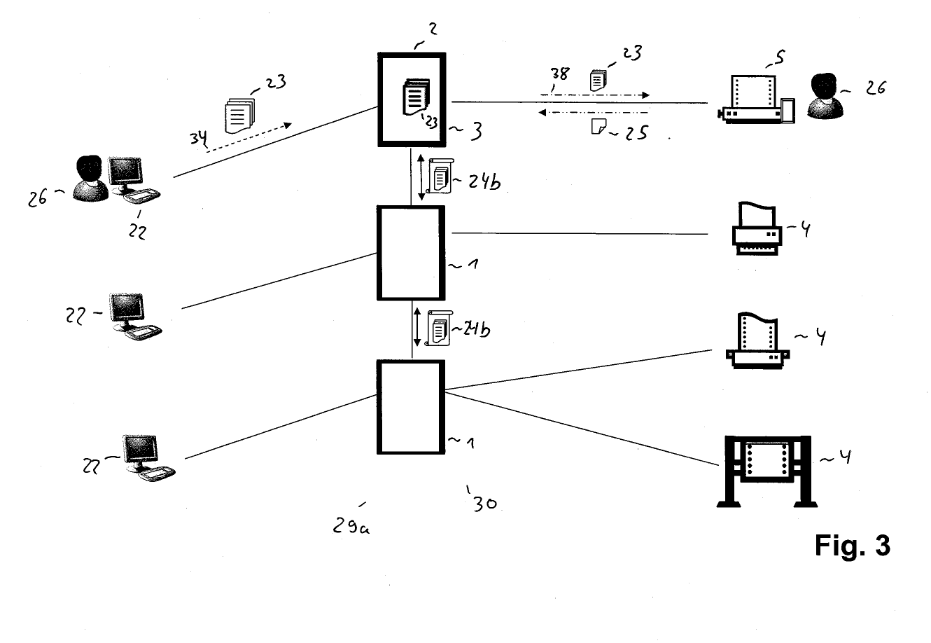

FIG. 3 is a chart showing the routing of one print job 23 from the storing print server 2 to a selected printer 5. The storing print server 2 is also the designated print server 3 of the printing system 30.

A user 26 is sending 34 from a client terminal 22, connected to the network 29a, one print job 23 in a printer ready format. The print job 23 is stored on the storing print server 2, which shares print job information 24b about the print ready status of the print job 23 on the storing print server 2 with the other print servers 1 of the network 29a.

The print job 23 on the storing print server may be releasable by any device 1,2,3,4,5,22 within the network 29a, especially by the printers 4 connected and designated with the print servers 1,2,3. In FIG. 3 one printer 5 is designated for one designated print server 3, which is also in this case the storing print server 2. The user 26 identifies herself/himself and requests release for printing of the print job 23 on this selected printer 5. The identification of the user 26 may be ensured by an electronic card or user/password authentication on one of the printers 4. This printer 4 is chosen by this identification process as the selected printer 5 for the actual print job 23. The release request 25 is routed to the storing print server 2 and the storing print server 2 sends the print job 23 to the selected printer 5. In FIG. 3 the storing print server 2 is also the designated print server 3 of the selected printer 5, which manages the selected printer 5. After the print job 23 is printed on the selected printer 5, the print job 23 is deleted by the storing print server 2. Print job information 24b about the deletion of the actual print job 23 by the storing print server 2 is shared once again between the print servers 1,2,3 of the network 29a.

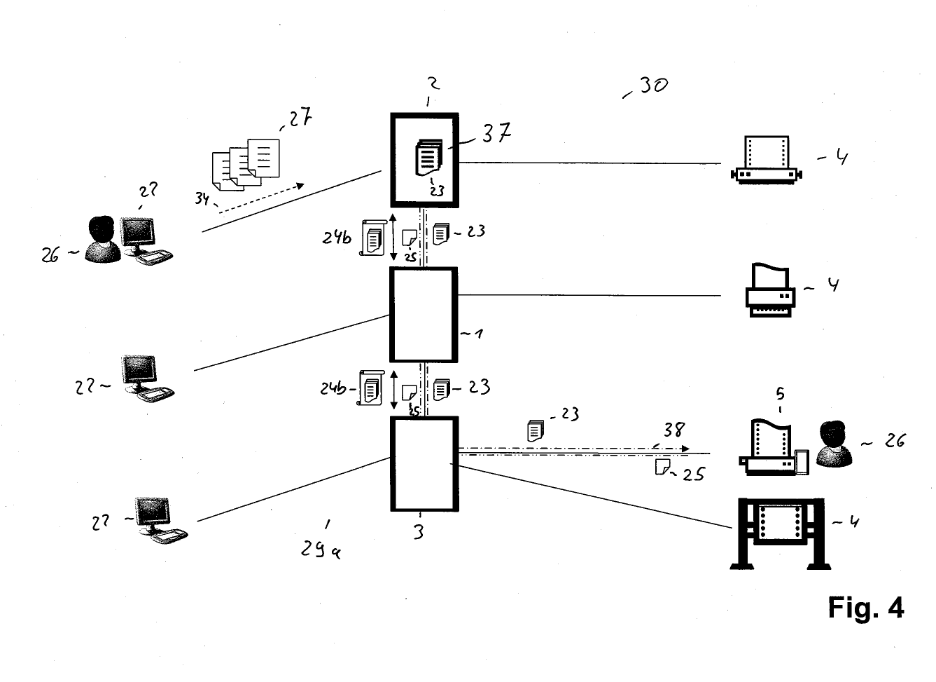

FIG. 4 is a chart showing the routing of one print job 23,27 from the storing print server 2 to the designated print server 3. The user 26 sends 34 one format convertible print job 27 to the storing print server 2, which is in this case connected directly to the client terminal 22 of the user 26. The format convertible print job 27 may be printed out on a number of printers, but has not the appropriate format for the designated printer 5. The format of the format convertible print job 27 might be a general print job format, such as Postscript (PS), Portable Document Format (PDF) or the Printer Command Language (PCL). Favourably, a raster image processor on the storing print server 2 converts the format of the format convertible print job 27 into an applicable format of the print job 23 for the selected printer 5. In the embodiment of FIG. 4 the storing print server 2 is selected by the user 26 as it is the print server 1 at the shortest distance from the terminal 22 used by the user 26 among the print servers 1,2,3 of the network 29a. In another embodiment, the storing print server 2 of the printing system 30 is selected as it is the most frequently used print server 1 by the specific user 26. The information about the most frequently used print server 1 of the user 26 may be shared also as a print job information 24a,24b between the print servers 1,2,3, such as described in WO 2008/129011 A1.

In FIG. 4 the storing print server 2 is also responsible for converting 37 the format convertible print job 27 into a print job 23 having a format, used by the selected printer 5. The print job information 24b about the format of the format convertible print job 27 is shared between all print servers 1,2,3 as part of the print job information 24b. Print job information 24b may be any information about the print job, such as the print job name, file size, the related user and/or storing location on one of the print servers 1,2,3. Print job information 24b is extracted by the storing print server 2 from the header of the print job 23 stored on the storing print server 2.

As already described with reference for FIG. 3, the selected printer 5 may be selected by the user 26 by going to the selected printer 5 and if required, authenticating herself/himself at the printer 4. The selected printer 5 is designating at the print server 3 and the print server 3 manages the selected printer 5. In FIG. 4 the storing print server 2 manages the format conversion 37 of the format convertible print job 27. After the format conversion 37 on the storing print server 2 the designated print server 3 of the selected printer 5 manages the routing of the print job 23 to the selected printer 5. Also the deletion of the print job 23 on the storing print server 2 is managed by the designated print server 3.

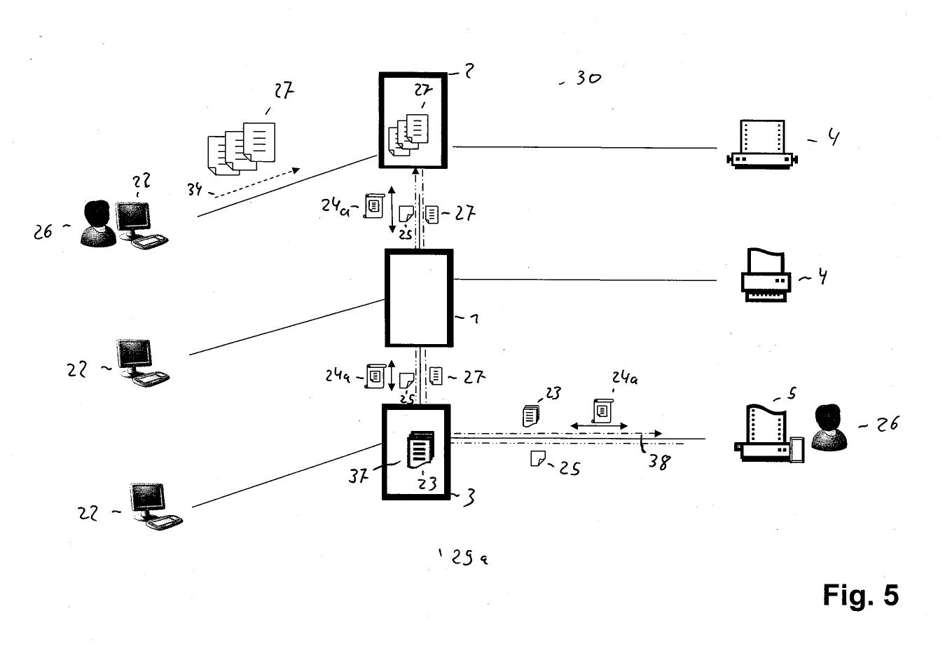

FIG. 5 shows the routing of one format convertible print job 27 from the storing print server 2 to the designated print server 3, which converts 37 the format convertible print job 27 into an appropriate print format of the print job 23.

The user 26 sends 34 a format convertible print job 27 from the client terminal 22 as part of the network 29a to the storing print server 2. In the embodiment of FIG. 5 the storing print server 2 is selected according to the shortest connection between the used client terminal 22 and one of the print servers 1,2,3 within the network 29a. Information 24a about the format convertible print job 27 on the storing print server 2 is shared between all print servers 1,2,3. When the user 26 accesses one of the printers 4,5, this printer 5 will be the selected printer 5 for this format convertible print job 27. In the embodiment of FIG. 5 every printer 4,5 is assigned to one specific print server 1,2,3, which manages the designated printer 4,5. Because of that, the functionality of the designated printers 4,5 may be enhanced, especially if the designated printers 4,5 have only limited print management and/or network resources, such as ink jet printers. The designated print server 3 manages the print capabilities and may provide additional functionalities for the selected printer 5, such as enhanced network functions or a complex print job management by spooling the print jobs 23 for the selected printer 5 on the designated print server 3 and not on the selected printer 5 itself.

The user 26 identifies herself/himself on the selected printer 5 and this identification of the user 26 is routed as a print job information 24a to print servers 1,2,3 of the printing system 30. Also the print job information 24a about the format convertible print job 27 on the storing print server 2 is shared with the selected printer 5. The storing print server 2 sends the print job information 24a to every printer 1,3 of the network 29a.

According to this embodiment of FIG. 5 print job information 24a may be displayed to the user 26 on the selected printer 5. The user 26 may select the format convertible print job 27 for printing according to the displayed print job information 24a. When the user 26 selects one format convertible print job 27 a release request relating to the selected format convertible print job 27 is submitted from the selected printer 5 to the network 29a. The designated print server 3 routes the release request 25 to all print servers 1,2 in the network 29a. According to the release request 25 the storing print server 2 sends the format convertible print job 27 to the requesting designated print server 3. The designated print server 3 converts 37 the format convertible print job 27 into a print job 23 with an appropriate format for the selected printer 5. After the print format conversion 37 the designated print server 3 releases the print job 23 to the selected printer 5 for printing. The print job 23 may be deleted from the designated print server 3, in case the printing of the print job 23 is finished on the selected printer 5.

In contrast to commonly used print queues, such as XML Paper Specification (XPS) or Graphics Device Interface (GDI) print paths, for storing the print job 23 within the print queue, according to the present invention the print job 23 is stored on the designated print server 3 and not within a print queue of the selected printer 5. Because of that, the print job 23 may be created, shared, printed, viewed, converted, deleted and/or archived on the file system of the designated print server 3. In the event that the print job 23 is deleted from the storing print server 3, information 24b (not shown in FIG. 5) about the deletion of the print job 23 from the designated print server 3 is also shared between all print servers 1,2,3. Therefore the actual status of every print job 23,27, regardless if in a appropriate format or not, is shared between all print servers 1,2,3.

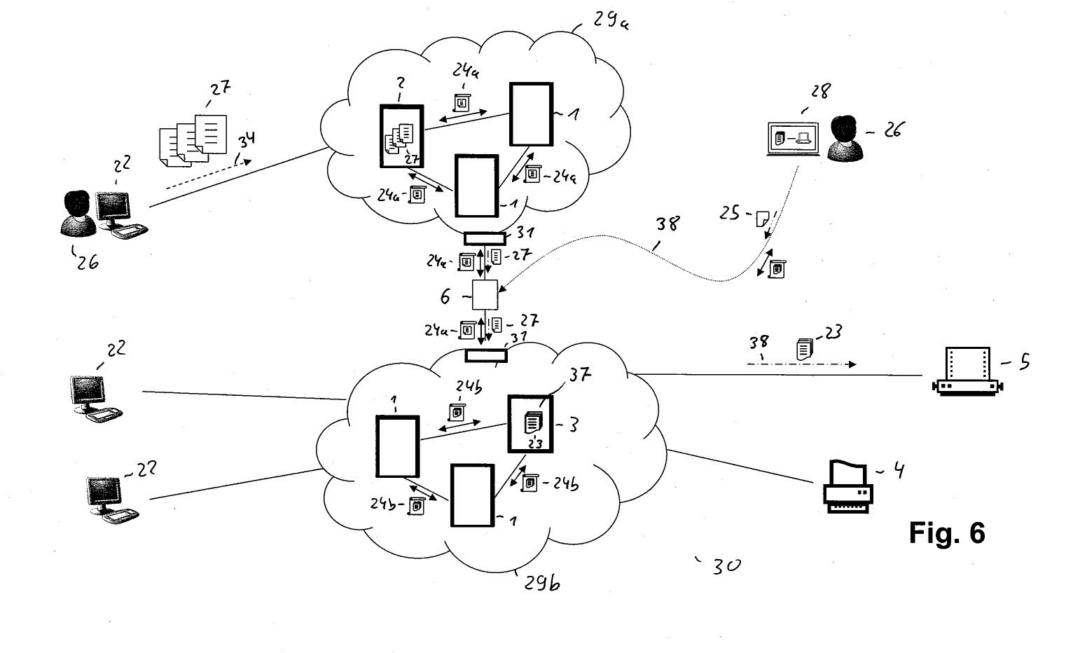

According to the embodiment of FIG. 6 the release request 25 of the print job 23,27 is managed by a mobile device 28 connectable to the network 29a.

The user 26 prepares the format convertible print job 27 on the client terminal 22 and sends the format convertible print job 27 to a first network 29a of the printing system 30. The network 29a may be a sub-network of the printing system 30, such as an intranet or a network 29a with different network protocols, for example a Bluetooth (standard IEEE 802.15.1) in relation to a mobile phone network. The network 29a may also be a cloud computing system with shared servers providing system resources, software, and data to computers and other devices on demand.

The format convertible print job 27 is stored on the storing print server 2, located within the first network 29a. The print job information 24a about the format convertible print job 27 is shared between all print servers 1,2 of the first network 29a. The first network 29a is connected by gateways or routers 31 with a second network 29b. The second network 29b may use a different network protocol from the first network 29a. Also the second network 29b comprises on a number of print servers 1,3 and is connectable with a number of printers 4,5 and client terminals 22. The print job information 24a about the format convertible print job 27 on the storing print server 2 is also shared within the second network 29b.

The user 26 may use the release device 28, such as a mobile phone, a tablet-PC or a laptop, for releasing the print job 23,27 by a release request 25 in relation to the selected printer 5. Alternatively the release request may be sent by one printer 1,2,3 of the network 29a,29b, such as disclosed in one of the above mentioned embodiments of FIGS. 3 to 5. The release device 28 is connected via the gateway 31 or via the web/mail server 6 with the printing system 30 and print job information 24a, 24b are shared with the release device 28 too. In this case the print job information 24a,24b may be displayed on the release device 28. Additionally, possible available printers 4,5 in the vicinity of the release device 28 or printers 4 having sufficient print resources and/or on the designated print server 3 for the selected printer 5 may be displayed on the release device 28. It is also possible to forward directly a print job 23,27, regardless of the format, from the release device 28 to the network 29a,29b of the printing system 30.

According to the embodiment of FIG. 6 the release request 25 of the mobile device 28 about the format convertible print job 27 on the storing print server 2 is sent to the gateway 31 or web/mail server 6 within the printing system 30. The status of a number of printers 4,5 within the network 29a,29b,29c is monitored and used for selecting and displaying appropriate printers 4,5 for a possible print out on the mobile device 28. Because the print job information 24a about the format convertible print job 27 on the storing print server 2 of the first network 29a is shared between all networks 29a,29b of the printing systems 30, the format convertible print job 27 is routed to the designated print server 3 of the selected printer 5 of the second network 29b. The print server 1,2,3 and/or the printer 4,5 and/or release device 28 share the print job information 24a,24b about the stored print job 23,27 within pre-defined time intervals, such as every two minutes, and/or if a change of print job information 24a,24b about the stored print job 3,27 is detected in the printing system 30. The designated print server 3 is selected in accordance with specific reasons and conditions, such as the nearest vicinity to the selected printer 5 or specific capabilities or functions for converting 37 format convertible print jobs 27.

The format convertible print job 27 is converted 37 on the designated server 3 into a print job 23 with a print-ready format for the selected printer 5. Print job information 24b about the converted print job 23 is shared between all print servers 1,3 of the second network 29b. Based on the release request 25 of the release device 28 the print job 23 is released 38 by the designated print server 3 to the selected printer 5. After the print out of the print job 23 is finished on the selected printer 5, the print job 23 may be deleted from the designated print server 3. Print job information 24b about the deletion of the print job 23 on the designated print server 3 is shared between all print servers 1,2,3 of all networks 29a,29b.

Based on different format convertible print jobs 27 or different print jobs 23, the storing print server 2 and/or designated print server 3 and/or selected printer 5 for different format convertible print jobs 27 or different print jobs 23 may be different.

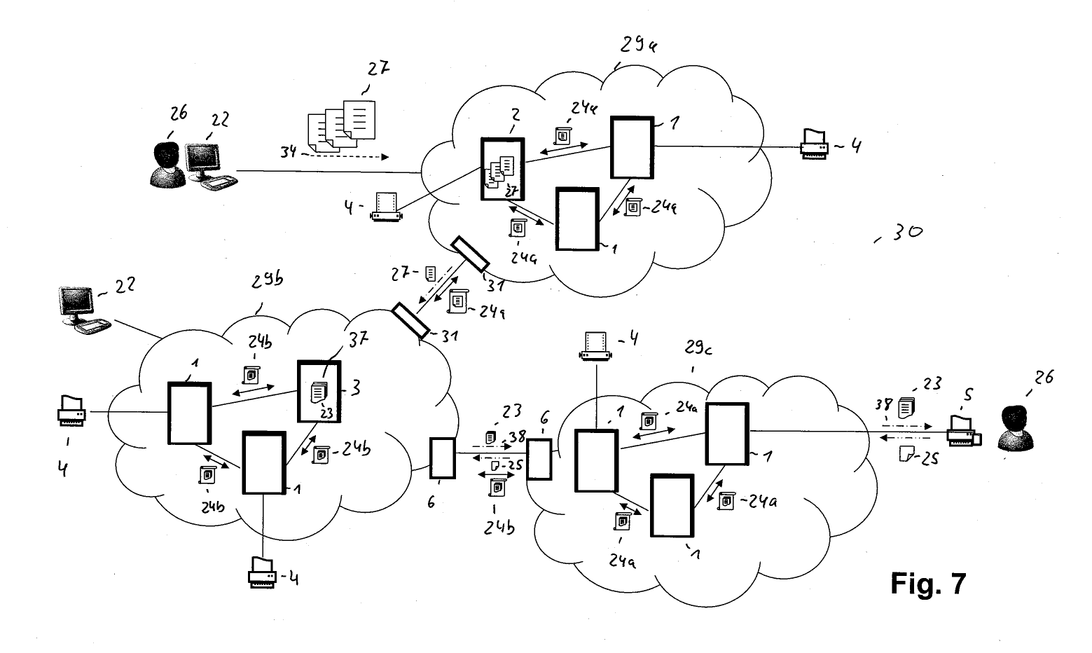

According to the embodiment of FIG. 7 the release request 25 of the print job 23,27 are managed within the printing system 30 of three networks 29a,29b,29c. The different networks 29a,29b,29c are connected by gateways or routers 31 for converting the different used network protocols. Alternatively web/mail servers 6 are used for managing email messages or messages via HTTP-connections for sending the print job information 24b, the release request 25 and/or the print job 23 in an appropriate network protocol via the networks 29a,29b,29c.

The user 26 sends the format convertible print job 27 from one of the client terminals 22 to the first network 29a, which is stored on the selected storing print server 2. The print job 27 is stored on the storing print server 2 and is released 38 to the selected printer 5 by an electronic data exchange via the printing system 30 based on a network protocol of at least one of the networks 29a,29b,29c. Because of that, there is no need for providing a print queue and the print jobs 23,27 are stored within the file system of the storing print server 2. Print job information 24a about the format convertible print job 27 is shared within the first network 29a and via the gateway 31 with the second network 29b. One of the print servers 1,3 within the second network 29b is designated for the format convertible print job 27 and the format convertible print job 27 is routed to the designated print server 3 via the gateways 31 between the first and second network 29a,29b. Print job information 24b about the print job 23 on the designated print server 3 is shared between all networks 29a,29b,29c. When the user 26 authenticates herself/himself at a selected printer 5, release request 25 is routed to the designated print server 3, which releases the print job 23 via the third network 29c to the selected printer 5 for printing out. Prior to release, the format convertible print job 27 it converted 37 on the designated print server 3 in a print job 23 having a printer ready format. The designated print server 3 may be selected according to its recourses or capabilities for converting format convertible print job 27. This conversion 37 is only necessary if the format convertible print job 27 is not appropriate for the selected printer 5. The designated print server 3 may be located in a network 29b different to the network 29c of the selected printer 5. After finishing the print out of the print job 23 on the selected printer 5, the print job 23 may be deleted or archived and the print job information 24b about the deletion or archiving is shared between all networks 29a,29b,29c of the printing system 30.

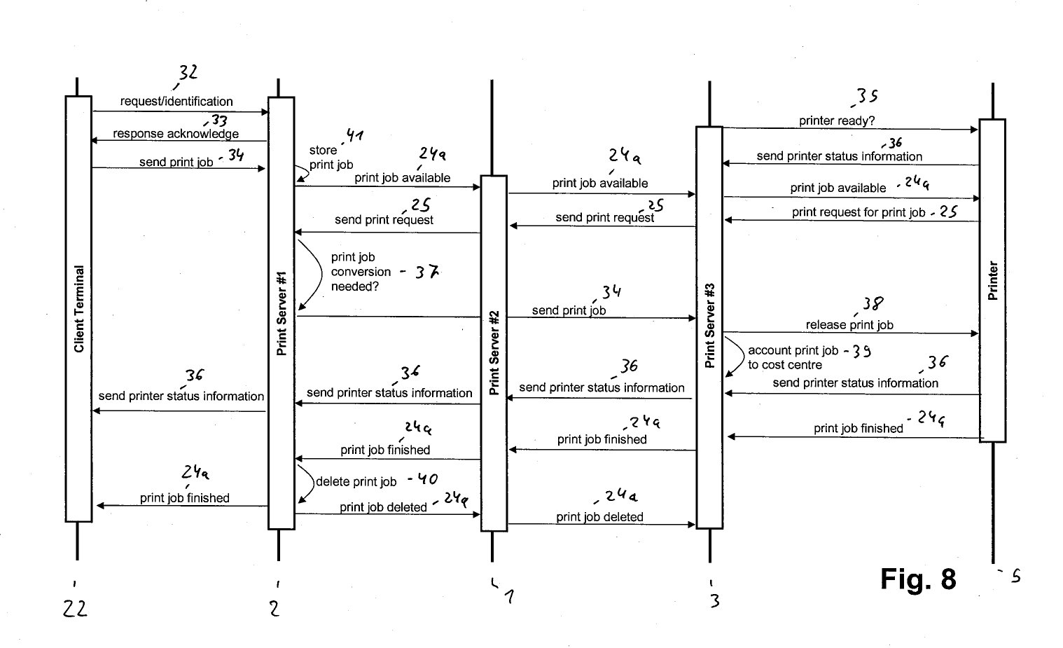

FIG. 8 is a Unified Modelling Language (UML) diagram showing three print servers 1,2,3 and one selected printer 5. The selected printer 5 in this example is managed by the print server 3, which is the designated print server 3 for the selected printer 5. The

The client terminal 22 builds up a connection to one of the print servers 1,2,3 registers 32 as a client terminal 22 at one of the print servers 1,2,3, which is according to the embodiment of FIG. 8 the storing print server 2. The storing print server 2 may be selected in accordance with various reasons or conditions for every print job 23 (not shown in FIG. 8). The storing print server 2 acknowledges 33 the request 32 and the client terminal 22 sends 34 the print job 23 (not shown in FIG. 8) to the storing print server 2. The storing print server 2 generates print job information 24a, which are shared between every print server 1,2,3. Independently, the selected printer 5 connects itself to its designated print server 3, which manages the selected printer 5. The selected printer 5 sends printer status information 36 to the designated print server 3 after receiving a printer ready request 35.

The user 26 (not shown in FIG. 8) may authenticate on the selected printer 5 and generates a release request 25 on the selected printer 5 for a selected print job 23. This release request 25 is shared between all print servers 1,2,3. Based on the print job information 24a the storing print server 2 checks whether or not the format of the print jobs 23 has to be converted 37. The print job 23 is sent 34 from the storing print server 2 to the designated print server 3 for printing out. After receiving the print job 23 the designated print server 3 releases 38 the print job 23 to the selected printer 5. If necessary the designated print server 3 manages the costs of the print job 23 by charging 39 the costs to a specific cost centre. The printer status information 36 of the selected printer 5 in relation to the printing of the print job 23 is shared between all print servers 1,2,3.

Also all print job information 24a, such as the termination of the printing of the print job on the selected printer 5 or the deletion of the print job 23 from the storing print server 2 is shared between all printer servers 1,2,3, the client terminal 22 and the selected printer 5.

### REFERENCE NUMERALS

1 print server

2 storing print server

3 designated print server

4 printer

5 selected printer

6 web/mail server

7 central processing unit (CPU)

8 read only memory (ROM)

9 hard disk

10 random access memory (RAM)

11 display unit

12 operation unit

13 communication control unit

14 image reader

15 recording unit

16 image memory

17 image processing unit

18 authentication processing unit

19 card reader

20 I/O control unit

21 system bus

22 client terminal

23 print job

24a, 24b print job information

25 release request

26 user

27 format convertible print job

28 device

29a,29b,29c network

30 printing system

31 gateway

32 requesting and identification

33 responding acknowledge

34 sending print job

35 requesting printer ready

36 sending printer status information

37 print format conversion

38 releasing print job

29 accounting print job

40 deleting print job

41 storing print job

1. A printing system for printing a print job, the system having at least one printer and at least two print servers connected to a network, and the system comprising:
means for storing a received print job exclusively on one of the print servers;
means for sharing print job information about the stored print job between the print servers via the network; and
means for employing the print job information to send the print job from the storing print server via the network to the printer when a request for printing the print job on the printer is received.

2. A printing system as claimed in claim 1, wherein, when the printer on which the print job is to be printed is managed by one of the said print servers other than said storing print server, the managing print server is adapted to receive said request for printing and to employ the print job information to obtain the print job from the storing print server and to supply the obtained print job to the printer for printing.

3. A printing system as claimed in claim 1, further comprising:
means for updating the print job information after the printing of the print job; and
means for sharing the updated print job information between the print servers.

4. A printing system as claimed in claim 1, adapted to receive the request for printing the print job at the printer.

5. A printing system as claimed in claim 1, adapted to receive the request for printing from a network device, other than the printer and the print servers, connectable to said network.

6. Printing system as claimed in claim 1, wherein the print job is a postscript or printer command language format and in case the postscript or printer command language format of the print job is not usable for a selected printer a raster image processor converts the format of the format convertible print job into an applicable format of the print job for the selected printer, before the print job is released to the selected printer.

7. Printing system according to claim 1, wherein the print job information about the stored print job are shared between the print servers and the printer and a release device via the network.

8. Printing system according to claim 1, wherein the printer is identified within the network by a unique address and a device agent installed on one of the print servers and/or printers and/or the release device prepares and releases the print job to the selected printer by using the unique address.

9. Printing system according to claim 1, wherein the print job is stored on the storing print server and is released to the selected printer by an electronic data exchange via the network based on a network protocol of the network.

10. Printing system according to claim 1, wherein each printer is designated for one print server respectively and every designated print server manages the designated printer.

11. Printing system according to claim 1, wherein the print job is releasable from the storing print server by the printer and/or by another print server and/or by the release device connectable to the network.

12. Printing system according to claim 1, wherein the status of a number of printers within the network is monitored and used for selecting and displaying appropriate printers for a possible print out.

13. Printing system according to claim 1, further comprising means for designating the print server as a storing print server that is frequently used by a user for the management of her/his print jobs.

14. Printing system according to claim 1, wherein the storing print server is the designated print server that manages to the selected printer.

15. Printing system according to claim 1, wherein the print server and/or the printer and/or release device share the print job information about the stored print job within pre-defined time intervals and/or if a change of print job information about the stored print job is detected.

16. Printing system according to claim 15, wherein print servers and printers with a direct connection with each other are adapted to share print job information with one another, in event print job information changes are detected on at least one of the print servers and/or printer.

17. Printing system according to claim 1, wherein the storing print server accounts the print costs to an account for the print job on the storing print server after the release of the print job.

18. Printing system according to claim 17, wherein the accounting information of the print costs is shared as print job information between the print servers via the network.

19. Printing system according to claim 1, wherein the print job information about the stored print job comprises the name, storage location, data size, the related user and/or security information of the print job.

20. Printing system according to claim 1, wherein the print job information are extracted from the print job.

21. Printing system according to claim 1, wherein a number of networks of print servers are connected via gateways, especially internet gateways, and/or by a web/mail server and the print job information about the stored print job are also shared between the networks.

22. A method of printing a print job within a printing system with at least one printer and at least two print servers connected to a network for printing a print job and the print servers are configured to print the print job over the network on the printer, comprising the steps of:
storing the print job on one of the print servers and
sharing the print job information about the stored print job between the print servers via the network and
in case of a request for print out the print job on the printer sending the print job from the storing print server via the network to the selected printer.

23-24. (canceled)

25. A non-transitory storage medium storing a program executable by a printing system for printing a print job, the system having at least one printer and at least two print servers connected to a network, and the system comprising:
means for storing a received print job exclusively on one of the print servers;
means for sharing print job information about the stored print job between the print servers via the network; and
means for employing the print job information to send the print job from the storing print server via the network to the printer, when a request for printing the print job on the printer is received.
